(19) United States
(12) Patent Application Publication
(10) Pub. No.: US 2026/0149807 A1
(43) Pub. Date: May 28, 2026

(54) APPROXIMATE LARGE TRANSFORM FOR VIDEO CODING

(71) Applicant: GOOGLE LLC, Mountain View, CA (US)

(72) Inventors: Yunqing Wang, Palo Alto, CA (US); Jingning Han, Santa Clara, CA (US)

(21) Appl. No.: 19/395,053

(22) Filed: Nov. 20, 2025

Related U.S. Application Data
(60) Provisional application No. 63/724,582, filed on Nov. 25, 2024.

(51) Int. Cl. H04N 19/12; H04N 19/176; H04N 19/60; H04N 19/70

(52) U.S. Cl. CPC H04N 19/12; H04N 19/176; H04N 19/60; H04N 19/70

(57) ABSTRACT

Approximate large transform uses a two-stage transform process without increasing the transform size used for a given block. During encoding, a transform kernel is applied to each of multiple first stage transform blocks partitioned from a residual block, and transform coefficients resulting therefrom are interleaved into a second stage transform block to which the transform kernel is applied. Transform coefficients resulting from this second transform stage process are then output for further encoding and signaling within a bitstream. During decoding, an inverse transform is performed by applying the transform kernel against the transform coefficients of a second stage transform block, and the resulting coefficients are deinterleaved in a predefined scan order into first stage transform blocks. Inverse transforms are then performed by applying the transform kernel against each of the first stage transform blocks, and the resulting residual data is then output for further decoding and eventual display or storage.

### CROSS-REFERENCE TO RELATED APPLICATION(S)

This application claims the benefit of U.S. Provisional Application Ser. No. 63/724,582, filed on Nov. 25, 2024, the entire disclosure of which is herein incorporated by reference.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

Disclosed herein are, inter alia, systems and techniques for approximate large transform for video coding.

A method for encoding a video block according to an implementation of this disclosure comprises: determining a transform kernel and a transform size for transforming a residual block associated with the video block; obtaining first transform coefficients by performing, according to the transform kernel and the transform size, a first stage transform against first stage transform blocks partitioned from the residual block; determining a second stage transform block by interleaving the first transform coefficients; obtaining second transform coefficients by performing, according to the transform kernel and the transform size, a second stage transform against the second stage transform block; and outputting the second transform coefficients for further processing.

An apparatus for encoding a video block according to an implementation of this disclosure comprises: a memory; and a processor configured to execute instructions stored in the memory to: determine a transform kernel and a transform size for transforming a residual block associated with the video block; obtain first transform coefficients by performing, according to the transform kernel and the transform size, a first stage transform against first stage transform blocks partitioned from the residual block; determine a second stage transform block by interleaving the first transform coefficients; obtain second transform coefficients by performing, according to the transform kernel and the transform size, a second stage transform against the second stage transform block; and output the second transform coefficients for further processing.

A non-transitory computer readable storage medium according to an implementation of this disclosure has stored thereon instructions for encoding a video block that, when executed, cause a processor to: determine a transform kernel and a transform size for transforming a residual block associated with the video block; obtain first transform coefficients by performing, according to the transform kernel and the transform size, a first stage transform against first stage transform blocks partitioned from the residual block; determine a second stage transform block by interleaving the first transform coefficients; obtain second transform coefficients by performing, according to the transform kernel and the transform size, a second stage transform against the second stage transform block; and output the second transform coefficients for further processing.

A method for decoding an encoded video block according to an implementation of this disclosure comprises: determining, based on syntax elements decoded from a bitstream which includes the encoded video block, a transform kernel and a transform size for inverse transforming a second stage transform block associated with the encoded video block; obtaining first transform coefficients by performing, according to the transform kernel and the transform size, a first stage inverse transform against second transform coefficients of the second stage transform block; determining first stage transform blocks by deinterleaving the first transform coefficients; obtaining a prediction residual by performing, according to the transform kernel and the transform size, a second stage inverse transform against each of the first stage transform blocks; and outputting the prediction residual for further processing.

An apparatus for decoding an encoded video block according to an implementation of this disclosure comprises: a memory; and a processor configured to execute instructions stored in the memory to: determine, based on syntax elements decoded from a bitstream which includes the encoded video block, a transform kernel and a transform size for inverse transforming a second stage transform block associated with the encoded video block; obtain first transform coefficients by performing, according to the transform kernel and the transform size, a first stage inverse transform against second transform coefficients of the second stage transform block; determine first stage transform blocks by deinterleaving the first transform coefficients; obtain a prediction residual by performing, according to the transform kernel and the transform size, a second stage inverse transform against each of the first stage transform blocks; and output the prediction residual for further processing.

A non-transitory computer readable storage medium according to an implementation of this disclosure has stored thereon instructions for decoding an encoded video block that, when executed, cause a processor to: determine, based on syntax elements decoded from a bitstream which includes the encoded video block, a transform kernel and a transform size for inverse transforming a second stage transform block associated with the encoded video block; obtain first transform coefficients by performing, according to the transform kernel and the transform size, a first stage inverse transform against second transform coefficients of the second stage transform block; determine first stage transform blocks by deinterleaving the first transform coefficients; obtain a prediction residual by performing, according to the transform kernel and the transform size, a second stage inverse transform against each of the first stage transform blocks; and output the prediction residual for further processing.

These and other aspects of this disclosure are disclosed in the following detailed description of the implementations, the appended claims and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of an example of a video encoding and decoding system.

FIG. 2 is a block diagram of an example of a computing device that can implement a transmitting station or a receiving station.

FIG. 3 is a diagram of an example of a video stream to be encoded and decoded.

FIG. 4 is a block diagram of an example of an encoder.

FIG. 5 is a block diagram of an example of a decoder.

FIG. 6 is an illustration of examples of portions of a video frame.

FIG. 7 is an illustration of a residual block from which transform blocks are identified.

FIG. 8 is an illustration of an example of coefficient deinterleaving for video coding using approximate large transform.

FIG. 9 is a flowchart diagram of an example of a technique for video encoding using approximate large transform.

FIG. 10 is a flowchart diagram of an example of a technique for video decoding using approximate large transform.

### DETAILED DESCRIPTION

Video compression schemes may include breaking respective images, or frames, of a video stream into smaller portions, such as blocks, and generating an encoded bitstream by using encoding techniques to limit the information included for respective blocks thereof. The bitstream can be decoded to re-create the source frames from the limited information. A video stream can be compressed (i.e., encoded) by a variety of techniques to reduce the bandwidth required to transmit or store the video stream. Similarly, a variety of techniques can be used to decompress (i.e., decode) a compressed video stream from a bitstream, to prepare the video stream for viewing or further processing. For example, a video compression scheme can include transforming pixel values of a prediction residual block of a current block into transform coefficients. The transform coefficients are quantized and entropy coded into an encoded bitstream. A decoder inverse transforms the encoded transform coefficients to decode or decompress the encoded bitstream to prepare the video stream for viewing or further processing, such as by decoding and outputting the current block to an output video stream.

There may be many different transform sizes available for transforming the pixel values of a prediction residual block, such as based on the size of the prediction residual block representing the prediction residual. For example, where the prediction residual block is 16×16, the transform size may be 16×16, 8×8, or 4×4. The maximum transform size available for a codec is typically one fourth the maximum prediction block size for the codec. For example, in AV1, the maximum prediction block size is 128×128 and the maximum transform size is 64×64. Generally, larger transform sizes are useful for processing flat (e.g., smooth, non-textured, or low motion) areas within a block as they can effectively operate against large portions of a block without incurring quality loss, while smaller transform sizes are useful for processing non-flat (detailed, textured, or high motion) areas within a block as they can focus on details that should be preserved to prevent quality loss.

Recent video codec work explores increasing the maximum prediction block size beyond 128×128, such as to 256×256. Doing so would enable greater coding performance for videos, especially those with relatively large resolutions (e.g., 1080p and above) as large resolution video frames tend to include large areas of flat content. With the maximum prediction block size being increased, increases to the maximum transform size should also be contemplated to maintain these coding gains. However, directly increasing the transform sizes available to a codec would also increase its complexity, which would be particularly troublesome in hardware video coder use cases and may accordingly render hardware approaches infeasible.

Implementations of this disclosure address problems such as these using approximate large transform for video coding, by which a large, two-stage transform process is performed for encoding and decoding without increasing the transform size used for a given block. During encoding, a rate-distortion optimization (RDO) process is performed to select a transform kernel, which, during a first transform stage, is applied to each of multiple transform blocks (referred to as “first stage transform blocks”) partitioned from a residual block. Thereafter, during a second transform stage, low-frequency band coefficients are gathered from each of the first stage transform blocks and interleaved into a new transform block (referred to as a “second stage transform block”) to which the transform kernel is applied to further exploit the inter-correlation between the transform coefficients. The transform coefficients resulting from this second transform stage process are then output for further encoding and signaling within a bitstream, alongside relevant syntax elements indicating the kernel and transform size. During decoding, based on a determination to use an approximate large transform (e.g., based on the signaling of a syntax element within the bitstream), the transform coefficients associated with a second stage transform block and indications of the transform kernel and size are decoded from the bitstream. During a first stage, an inverse transform is performed by applying the transform kernel against the transform coefficients, and the resulting coefficients are then deinterleaved in a predefined scan order into separate buffers for individual first stage transform blocks. During a second stage, inverse transforms are performed by applying the transform kernel against each of the first stage transform blocks, and the resulting residual data is then output for further decoding and eventual display or storage. The implementations of this disclosure accordingly and effectively enable large transform size processing without the direct use thereof, thereby avoiding costly hardware and other complexities while scaling transform processing for increased block sizes.

References are made throughout this disclosure to transform coefficients represented by transform blocks. As used herein, the representation of a number of transform coefficients by a transform block size refers to the number of transform coefficients that are included in a transform block of that transform block size. For example, a 32×32 transform block represents 1,024 transform coefficients because a 32×32 transform block includes 1,024 transform coefficients. Thus, a statement or other expression that transform coefficients are represented by a 32×32 block size means that there are 1,024 such transform coefficients. That statement or other expression also means that the cardinality of those transform coefficients is 1,024.

While reference is made herein by example to superblocks, macroblocks, blocks, and the like, as are commonly used in video codecs such as VP9, AV1, and the currently in-development AV2, the implementations of this disclosure may be used with other video coding structures. In one particular but non-limiting example, the implementations of this disclosure may be used with CTUs, CUs, PUs, and the like, as are commonly used in video codecs such as H.265, referred to as High-Efficiency Video Coding, and H.266, referred to as Versatile Video Coding. Accordingly, references herein to particular video coding structures such as superblocks, macroblocks, blocks, and the like shall be regarded as expressions of non-limiting example video coding structures with which the implementations of this disclosure may be used.

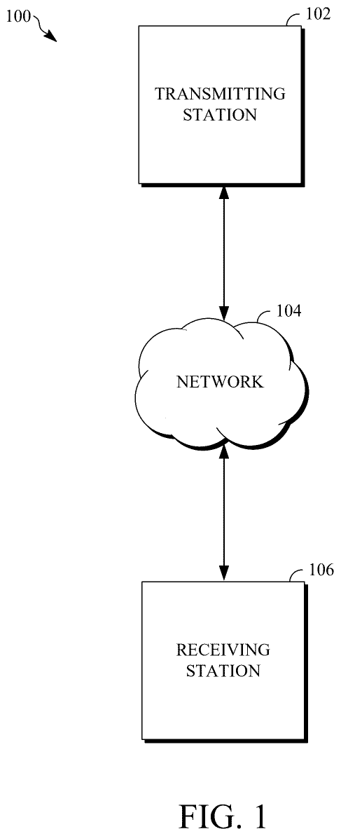

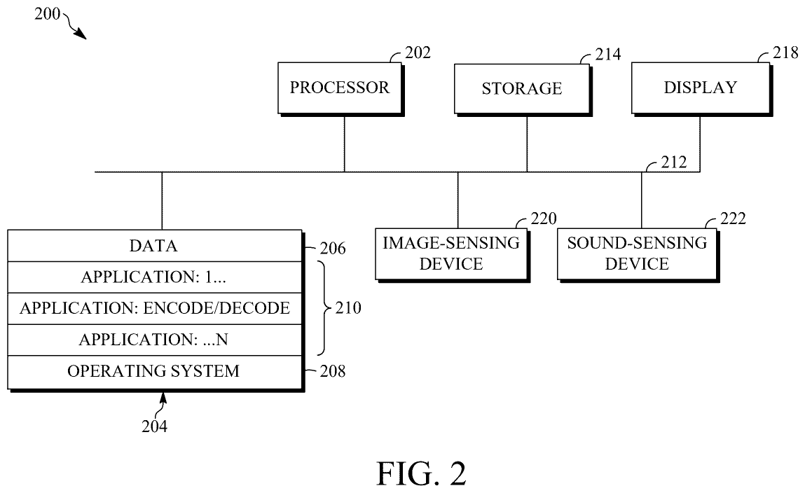

Further details of techniques for approximate large transform for video coding are described herein with initial reference to a system in which such techniques can be implemented. FIG. 1 is a schematic of an example of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used (e.g., a Hypertext Transfer Protocol-based (HTTP-based) video streaming protocol).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

In some implementations, the video encoding and decoding system 100 may instead be used to encode and decode data other than video data. For example, the video encoding and decoding system 100 can be used to process image data. The image data may include a block of data from an image. In such an implementation, the transmitting station 102 may be used to encode the image data and the receiving station 106 may be used to decode the image data.

Alternatively, the receiving station 106 can represent a computing device that stores the encoded image data for later use, such as after receiving the encoded or pre-encoded image data from the transmitting station 102. As a further alternative, the transmitting station 102 can represent a computing device that decodes the image data, such as prior to transmitting the decoded image data to the receiving station 106 for display.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include encoding and/or decoding software that performs, amongst other things, approximate large transform for video coding as described herein.

The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200.

Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

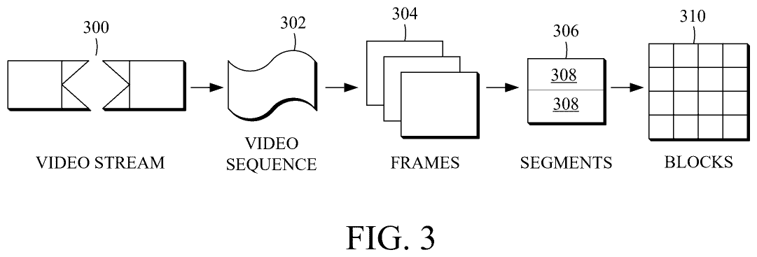

FIG. 3 is a diagram of an example of a video stream 300 to be encoded and decoded. The video stream 300 includes a video sequence 302. At the next level, the video sequence 302 includes a number of adjacent video frames 304. While three frames are depicted as the adjacent frames 304, the video sequence 302 can include any number of adjacent frames 304. The adjacent frames 304 can then be further subdivided into individual video frames, for example, a frame 306.

At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, MxN pixels in the frame 306, in which M and N may refer to the same positive integer value or to different positive integer values. The blocks 310 can also be arranged to include data from one or more segments 308 of pixel data. The blocks 310 can be of any suitable size, such as 4×4 pixels, 8×8 pixels, 16×8 pixels, 8×16 pixels, 16×16 pixels, or larger up to a maximum block size, which may be 128×128 pixels or another M×N pixels size.

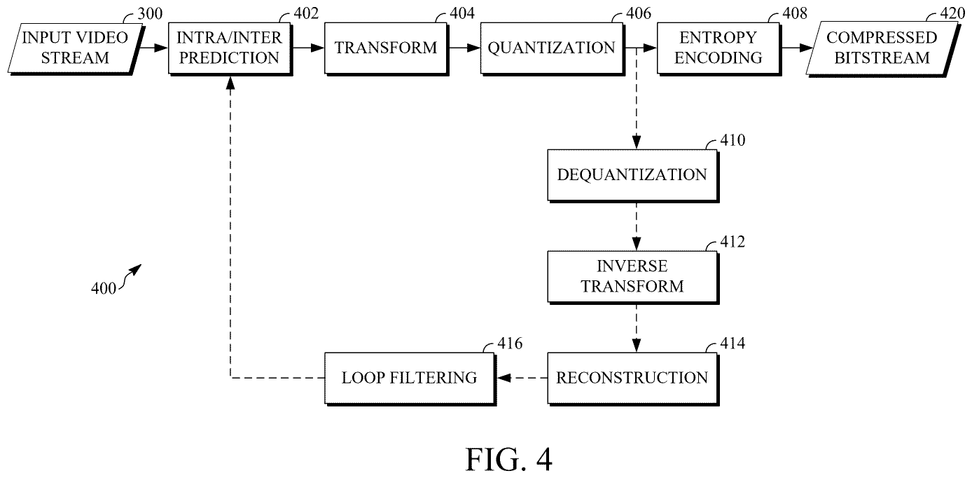

FIG. 4 is a block diagram of an example of an encoder 400. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In some implementations, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

In some cases, the functions performed by the encoder 400 may occur after a filtering of the video stream 300. That is, the video stream 300 may undergo pre-processing according to one or more implementations of this disclosure prior to the encoder 400 receiving the video stream 300. Alternatively, the encoder 400 may itself perform such pre-processing against the video stream 300 prior to proceeding to perform the functions described with respect to FIG. 4, such as prior to the processing of the video stream 300 at the intra/inter prediction stage 402.

When the video stream 300 is presented for encoding after the pre-processing is performed, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding or arithmetic coding. The compressed bitstream 420 can also be referred to as an encoded video stream or encoded video bitstream, and the terms will be used interchangeably herein.

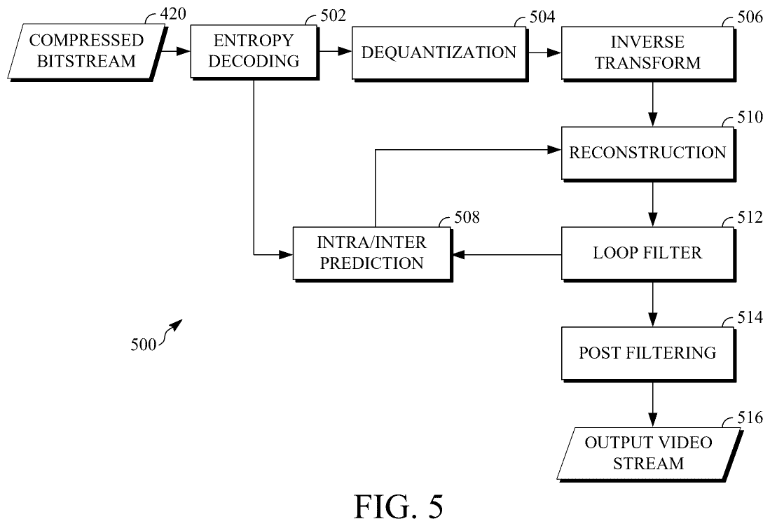

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual).

At the reconstruction stage 414, the prediction block that was predicted at the intra/inter prediction stage 402 can be added to the derivative residual to create a reconstructed block. The loop filtering stage 416 can apply an in-loop filter or other filter to the reconstructed block to reduce distortion such as blocking artifacts. Examples of filters which may be applied at the loop filtering stage 416 include, without limitation, a deblocking filter, a directional enhancement filter, and a loop restoration filter.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of an example of a decoder 500. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106. In some implementations, the decoder 500 is a hardware decoder.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filter stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Examples of filters which may be applied at the loop filtering stage 512 include, without limitation, a deblocking filter, a directional enhancement filter, and a loop restoration filter. Other filtering can be applied to the reconstructed block. In this example, the post filter stage 514 is applied to the reconstructed block to reduce blocking distortion, and the result is output as the output video stream 516. The output video stream 516 can also be referred to as a decoded video stream, and the terms will be used interchangeably herein.

Other variations of the decoder 500 can be used to decode the compressed bitstream 420. In some implementations, the decoder 500 can produce the output video stream 516 without the post filter stage 514 or otherwise omit the post filter stage 514.

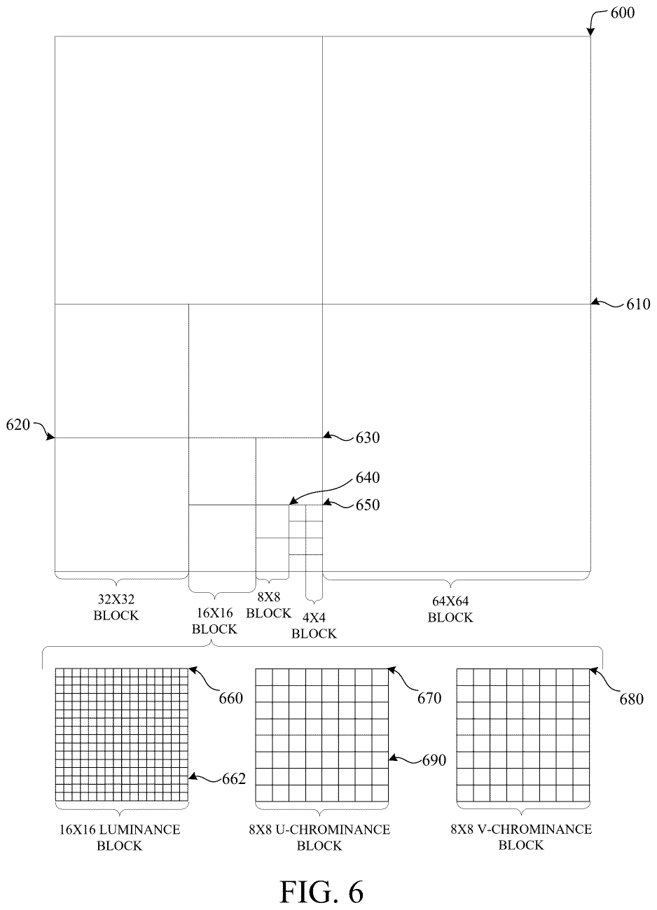

FIG. 6 is an illustration of examples of portions of a video frame 600, which may, for example, be the frame 306 shown in FIG. 3. The video frame 600 includes a number of 64×64 blocks 610, such as four 64×64 blocks 610 in two rows and two columns in a matrix or Cartesian plane, as shown. Each 64×64 block 610 may include up to four 32×32 blocks 620. Each 32×32 block 620 may include up to four 16×16 blocks 630. Each 16×16 block 630 may include up to four 8×8 blocks 640. Each 8×8 block 640 may include up to four 4×4 blocks 950. Each 4×4 block 950 may include 16 pixels, which may be represented in four rows and four columns in each respective block in the Cartesian plane or matrix. In some implementations, the video frame 600 may include blocks larger than 64×64 and/or smaller than 4×4. Subject to features within the video frame 600 and/or other criteria, the video frame 600 may be partitioned into various block arrangements.

The pixels may include information representing an image captured in the video frame 600, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used, wherein N and M are different numbers. For example, 32×64 blocks, 64×32 blocks, 16×32 blocks, 32×16 blocks, or any other size blocks may be used. In some implementations, N×2N blocks, 2N×N blocks, or a combination thereof, may be used.

In some implementations, coding the video frame 600 may include ordered block-level coding. Ordered block-level coding may include coding blocks of the video frame 600 in an order, such as raster-scan order, wherein blocks may be identified and processed starting with a block in the upper left corner of the video frame 600, or portion of the video frame 600, and proceeding along rows from left to right and from the top row to the bottom row, identifying each block in turn for processing. For example, the 64×64 block in the top row and left column of the video frame 600 may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block of the video frame 600 may include using quad-tree coding, which may include coding smaller block units within a block in raster-scan order. For example, the 64×64 block shown in the bottom left corner of the portion of the video frame 600 may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, coding the video frame 600 may include encoding the information included in the original version of the image or video frame by, for example, omitting some of the information from that original version of the image or video frame from a corresponding encoded image or encoded video frame. For example, the coding may include reducing spectral redundancy, reducing spatial redundancy, or a combination thereof. Reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of the video frame 600, and using a relatively small amount of information to represent each corresponding chrominance component for the portion of the video frame 600. For example, a portion of the video frame 600 may be represented by a high-resolution luminance component, which may include a 16×16 block of pixels, and by two lower resolution chrominance components, each of which represents the portion of the image as an 8×8 block of pixels. A pixel may indicate a value, for example, a value in the range from 0 to 255, and may be stored or transmitted using, for example, eight bits. Although this disclosure is described in reference to the YUV color model, another color model may be used. Reducing spatial redundancy may include transforming a block into the frequency domain using, for example, a discrete cosine transform. For example, a unit of an encoder may perform a discrete cosine transform using transform coefficient values based on spatial frequency.

Although described herein with reference to matrix or Cartesian representation of the video frame 600 for clarity, the video frame 600 may be stored, transmitted, processed, or a combination thereof, in a data structure such that pixel values may be efficiently represented for the video frame 600. For example, the video frame 600 may be stored, transmitted, processed, or any combination thereof, in a two-dimensional data structure such as a matrix as shown, or in a one-dimensional data structure, such as a vector array. Furthermore, although described herein as showing a chrominance subsampled image where U and V have half the resolution of Y, the video frame 600 may have different configurations for the color channels thereof. For example, referring still to the YUV color space, full resolution may be used for all color channels of the video frame 600. In another example, a color space other than the YUV color space may be used to represent the resolution of color channels of the video frame 600.

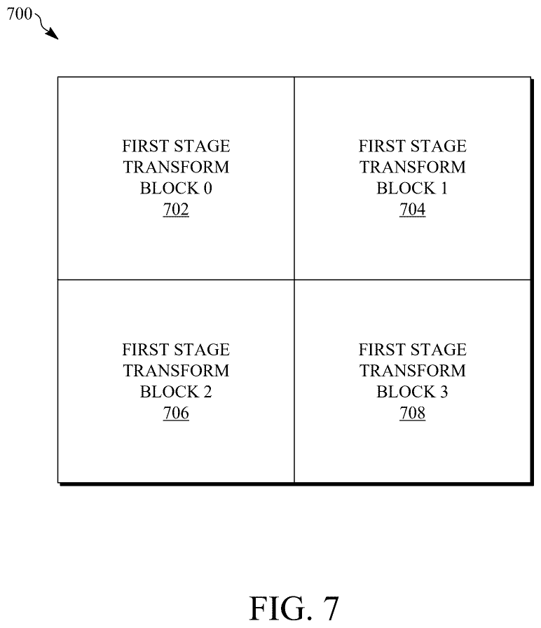

FIG. 7 is an illustration of a residual block 700 from which transform blocks 702 through 708 are identified. The residual block 700 represents a prediction residual determined (e.g., generated) for a video block under encoding. For example, the residual block may be output by the intra/inter prediction stage 402 shown in FIG. 4. While the residual block 700 is generally shown as having a square shape, in some cases, the residual block 700 may instead have another rectangular shape.

During a transform stage process (e.g., the transform stage 404 shown in FIG. 4), the residual block 700 is partitioned into the transform blocks 702 through 708 using a transform-level partitioning scheme. For example, the residual block 700 may be partitioned into the transform blocks 702 through 708 based on a measure of contents of portions of the residual block 700 (e.g., a degree to which objects, textures, or the like differ within those portions of the residual block 700), an RDO process performed against the residual block 700 to assess optimal partitions for transform-level partitioning, or the like. In the example shown, the residual block 700 is partitioned into four equally sized transform blocks 702 through 708. To illustrate, in one non-limiting example, the residual block 700 may be a 128×128 block and the transform blocks 702 through 708 may each be a 64×64 block. While four transform blocks 702 through 708 are shown, in some cases, other numbers of transform blocks may be partitioned from the residual block 700.

Because the residual block 700 is larger than each of the transform blocks 702 through 708, and thus because a goal of the transform process for the residual block 700 is to effectively apply a transform block directly to cover the entirety of the residual block although such a transform block would be too large for hardware coding, the transform partitioning enables large transform approaches for video coding.

Following the transform-level partitioning, an RDO process is performed to determine (e.g., select) a transform kernel to apply for transforming each of the transform blocks 702 through 708. The RDO process evaluates the rate-distortion costs resulting from transforming the transform blocks 702 through 708 using or not using individual transform kernel candidates. The transform kernel candidate with the optimal (e.g., lowest) rate-distortion cost is then determined (e.g., selected) as the transform kernel to use for the transform against the transform blocks 702 through 708. Non-limiting examples of the transform kernels include a discrete cosine transform (DCT) kernel, a discrete sine transform (DST) kernel, an asymmetric DST (ADST) kernel, and trained kernels (i.e., separable or non-separable kernels).

The transform kernel is then applied during each stage of a two-stage transform process performed against the transform blocks 702 through 708 to result in transform coefficients, which may be quantized (e.g., at the quantization stage 406 shown in FIG. 4), entropy encoded (e.g., at the entropy encoding stage 408 shown in FIG. 4), and signaled within a bitstream (e.g., the compressed bitstream 420 shown in FIGS. 4 and 5). During a first stage, the values within each of the transform blocks 702 through 708, which are first stage transform blocks as described above, are transformed using the transform kernel to result in sets of transform coefficients each associated with one of the transform blocks 702. For example, the first stage transform block 0 702 may be transformed to result in transform coefficients X0, X1, . . . XN; the first stage transform block 1 704 may be transformed to result in transform coefficients Y0, Y1, . . . YN; the first stage transform block 2 706 may be transformed to result in transform coefficients Z0, Z1, . . . ZN; and the first stage transform block 3 708 may be transformed to result in transform coefficients T0, T1, . . . TN.

During a second stage, the low-frequency band coefficients of each of the transform blocks 702 through 708 are then gathered (e.g., obtained, accessed, grouped, selected, or otherwise identified) to generate a new, second stage transform block (not shown) that is the same size as each of the transform blocks 702 through 708. In particular, gathering the coefficients to generate the second stage transform block includes interleaving the coefficients gathered from the transform blocks 702 through 708 such that the transform coefficients of the second stage transform block are simply an interleaved version of the transform coefficients of the first stage transform blocks 702 through 708 after the first stage transform is applied against those first stage transform blocks 702 through 708. For example, referring to the example referenced above, the interleaved transform coefficients of the second stage transform block may be expressed as X0, Y0, Z0, T0, X1, Y1, Z1, T1, X2, Y2, Z2, T2, X3, Y3, Z3, T3, and so on. The transform kernel is then applied again, this time against the second stage transform coefficient, to further exploit the inter-correlation between the transform coefficients interleaved within the second stage transform coefficient. The transform coefficients resulting from (i.e., as output of) the second stage are then output for further encoding and signaling.

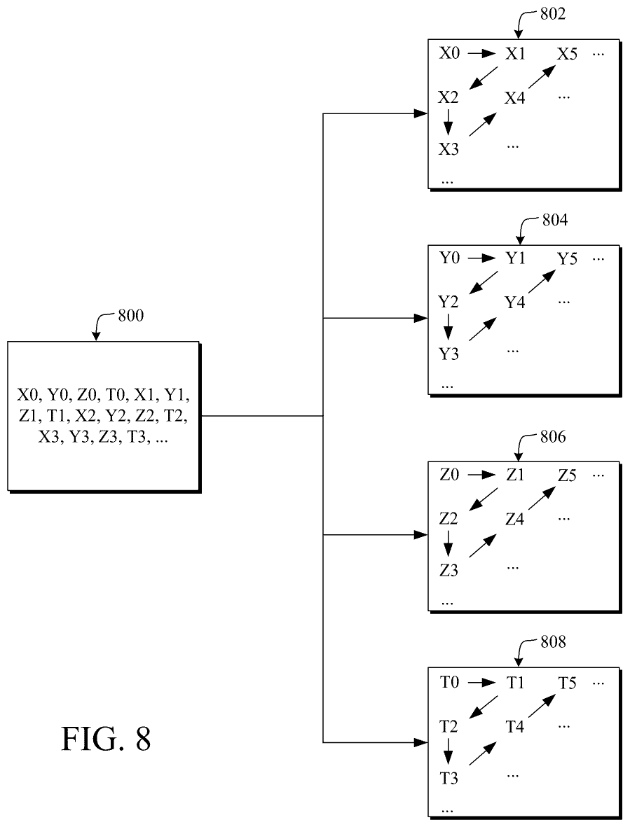

FIG. 8 is an illustration of an example of coefficient deinterleaving for video coding using approximate large transform. Whereas interleaving as described above occurs during encoding, deinterleaving occurs during decoding (as well as, in at least some cases, during the reconstruction loop at an encoder). For example, the deinterleaving may be performed at an inverse transform stage (e.g., the inverse transform stage 506 shown in FIG. 5). A second stage transform block 800 is shown as including interleaved transform coefficients. In the example shown, the second stage transform block 800, following the first stage inverse transform, includes interleaved transform coefficients X0, Y0, Z0, T0, X1, Y1, Z1, T1, X2, Y2, Z2, T2, X3, Y3, Z3, T3, and so on. The interleaved transform coefficients are output from a first stage inverse transform performed against a transform block decoded from a bitstream. For example, the first stage inverse transform may be performed according to information signaled within the bitstream, such as data indicating a transform kernel and/or size to use for the first stage inverse transform.

First stage transform blocks 802 through 808 are shown as including deinterleaved transform coefficients, in which each of the first stage transform blocks 802 through 808 thus includes only some of the interleaved transform coefficients included in the second stage transform block 800. In particular, in the example shown, the first stage transform block 802 includes deinterleaved transform coefficients labeled starting with X, the first stage transform block 804 includes deinterleaved transform coefficients labeled starting with Y, the first stage transform block 806 includes deinterleaved transform coefficients labeled starting with Z, and the first stage transform block 808 includes deinterleaved transform coefficients labeled starting with T. In one non-limiting example, the first stage transform blocks 802 through 808 may correspond to the first stage transform blocks 702 through 708 shown in FIG. 7. While four first stage transform blocks 802 through 808 are shown, in some cases, other numbers of first stage transform blocks may be involved in the deinterleaving process.

Following the first stage inverse transform performed against the second stage transform block 800, the interleaved transform coefficients are deinterleaved and respective ones of the deinterleaved transform coefficients are written to buffers associated with ones of the first stage transform blocks 802 through 808. For example, deinterleaved transform coefficients labeled starting with X are written to a buffer associated with the first stage transform block 802, deinterleaved transform coefficients labeled starting with Y are written to a buffer associated with the first stage transform block 804, deinterleaved transform coefficients labeled starting with Z are written to a buffer associated with the first stage transform block 806, and deinterleaved transform coefficients labeled starting with T are written to a buffer associated with the first stage transform block 808.

The transform coefficients that are written to a given buffer are written to the buffer in a predefined scan order (e.g., a zigzag or raster scan order) signaled within the bitstream from which the transform coefficients are decoded). In some cases, however, the order to which the transform coefficients are written to a given buffer may instead be dynamically determined at the decoder (i.e., rather than according to a scan order signaled within the bitstream. In any case, the first transform coefficient written to a given buffer (i.e., a transform coefficient labeled 0) generally will be the DC coefficient and the other transform coefficients written to the buffer will be AC coefficients. This further emphasizes the inter-block correlations, as the DC coefficients are expected to be correlated, and thus the deinterleaving realigns the transform coefficients of the same frequencies across the first stage transform blocks 802 through 808.

Once the deinterleaved transform coefficients are written to the respective buffers, a second stage inverse transform is performed for each of the first stage transform blocks 802 through 808 to result in values of a prediction residual which may be processed during a prediction stage (e.g., the intra/inter prediction stage 508 shown in FIG. 5). In particular, a second stage inverse transform is performed against the buffered transform coefficients associated with each of the first stage transform blocks 802 through 808 (e.g., to further reduce the inter-correlation between the transform coefficients) and the resulting values are written to a destination buffer associated with a residual block (i.e., a prediction residual) for the encoded video block. Once all values resulting from the second stage inverse transforms have been written to the destination buffer, further decoding may be performed such as by the reconstruction of the encoded video block according to the values in the destination buffer and a predication determined for the encoded video block.

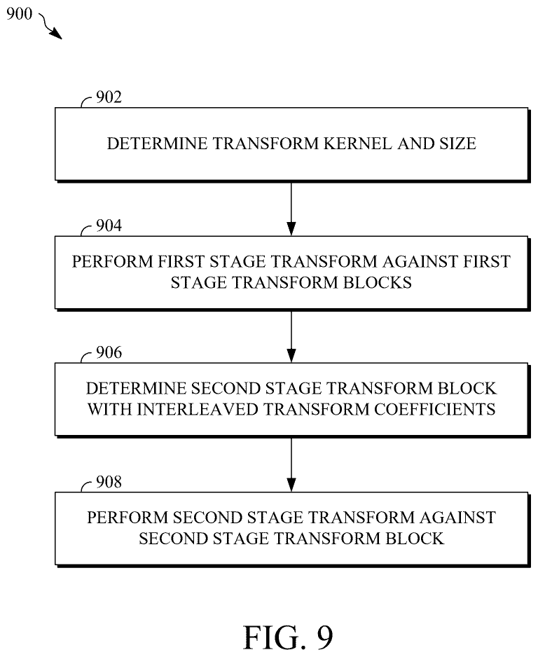

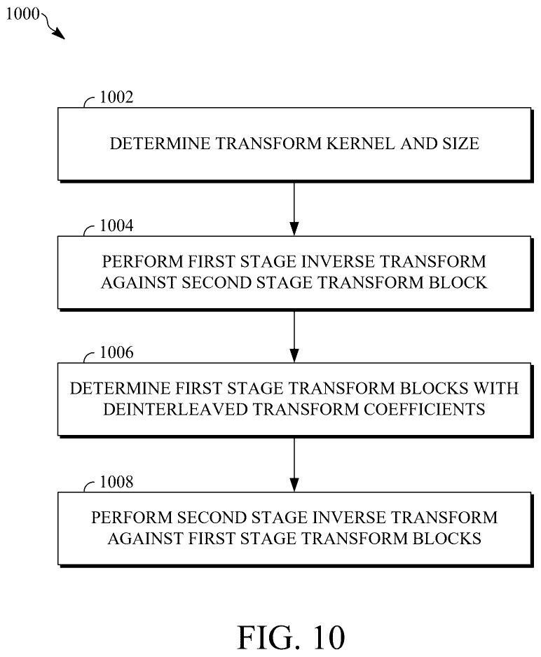

Further details of techniques for approximate large transform for video coding are now described. FIG. 9 is a flowchart diagram of an example of a technique 900 for video encoding using approximate large transform. FIG. 10 is a flowchart diagram of an example of a technique 1000 for video decoding using approximate large transform. The technique 900 and/or the technique 1000 may, for example, be wholly or partially performed at or otherwise in connection with a prediction stage of an encoder used to encode a video stream (e.g., the intra/inter prediction stage 402) or at or otherwise in connection with a prediction stage of a decoder used to decode a bitstream (e.g., the intra/inter prediction stage 508).

The technique 900 and/or the technique 1000 can be implemented, for example, as a software program that may be executed by computing devices such as the transmitting station 102 or the receiving station 106. For example, the software program can include machine-readable instructions that may be stored in a memory such as the memory 204 or the secondary storage 214, and that, when executed by a processor, such as the processor 202, may cause the computing device to perform the technique 900 and/or the technique 1000. The technique 900 and/or the technique 1000 can be implemented using specialized hardware or firmware. For example, a hardware component, such as a hardware coder, may be configured to perform the technique 900 and/or the technique 1000. As explained above, some computing devices may have multiple memories or processors, and the operations described in the technique 900 and/or the technique 1000 can be distributed using multiple processors, memories, or both.

For simplicity of explanation, the technique 900 and the technique 1000 are each depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 9, the technique 900 for video encoding using approximate large transform is shown. At 902, a transform kernel and a transform size are determined. The transform kernel and the transform size are determined for transforming a residual block associated with a video block to encode. Determining the transform kernel can include performing an RDO process against the residual block to select the transform kernel from amongst one or more candidate transform kernels based on rate-distortion costs determined for the candidate transform kernels. Determining the transform size can include performing a transform-level partitioning against the residual block according to energy concentrations (i.e., contents, details, and the like) represented within values of the residual block. Alternatively, one or both of the transform kernel or the transform size may be pre-defined. For example, the transform kernel may be one of DCT, DST, ADST, or a trained transform. In another example, the transform size may be one of 4×4, 4×8, 8×4, 8×8, 8×16, 16×8, 16×16, 16×32, 32×16, 32×32, 32×64, 64×32, or 64×64.

At 904, a first stage transform is performed according to the transform kernel and the transform size against first stage transform blocks. Performing the first stage transform against the first stage transform blocks includes applying the transform kernel against values within the first stage transform blocks to obtain (e.g., calculate, determine, or identify) first transform coefficients, in which each of the first stage transform blocks is of the transform size. The first transform coefficients include transform coefficients resulting from the transform performed against each of the first stage transform blocks. For example, where there are four first stage transform blocks, the first transform coefficients include four sets of transform coefficients, each corresponding to one of the four first stage transform blocks.

At 906, a second stage transform block with interleaved transform coefficients is determined. The second stage transform block is a transform block having the same transform size as each of the first stage transform blocks. Determining the second stage transform block includes interleaving the first transform coefficients obtained based on the first stage transform performed against the first stage transform blocks. Interleaving the first transform coefficients includes rearranging the various sets of transform coefficients of the first transform coefficients to align the inter-correlations between the sets of transform coefficients. In particular, interleaving the first transform coefficients includes arranging the DC coefficients of each of the first stage transform blocks together, followed by the first AC coefficients of each according to a scan order, followed by the second AC coefficients of each according to the scan order, and so on until all transform coefficients of all first stage transform blocks are interleaved and represented by (e.g., included in) the second stage transform block. The interleaved transform coefficients are written to (e.g., stored within) a buffer associated with the second stage transform block. Thus, the second stage transform block includes transform coefficients from multiple transform blocks (e.g., from each of the first stage transform blocks) rather than from a single transform block.

At 908, a second stage transform is performed according to the transform kernel and the transform size against the second stage transform block. Performing the second stage transform against the second stage transform block includes applying the transform kernel against the interleaved transform coefficients of the second stage transform block to obtain (e.g., calculate, determine, or identify) second transform coefficients. For example, applying the transform kernel against the interleaved transform coefficients can include reading the interleaved transform coefficients from the buffer associated with the second stage transform block. The second transform coefficients include transform coefficients resulting from the transform performed against the second stage transform block. The second transform coefficients are then output for further processing, for example, for quantization, entropy encoding, and signaling within a bitstream.

In some implementations, the technique 900 can include determining whether to use large approximate transform for transforming the video block to encode. For example, an encoder performing the technique 900 can perform an RDO process against the residual block associated with the video block to determine whether to use large approximate transform for transforming the values of the residual block. Where a determination is made to use large approximate transform for transforming the video block, the technique 900 proceeds to 902, where the transform kernel and transform size are determined. However, where a determination is made to not use large approximate transform for transforming the video block (i.e., such that a small transform size or other transform size for which the subject codec is configured for direct use), the technique 900 instead skips the processing at 902 through 908 and instead performs a conventional, direct transform against values of the residual block, which are then output for further processing at the encoder. In some implementations, the determination of whether to use large approximate transform for transforming the video block to encode may be limited to situations in which the residual block is larger than a threshold and/or has non-zero coefficients. For example, the threshold may be or be based on a maximum transform size for which a subject codec is configured for use.

In some implementations, the technique 900 can include signaling one or more syntax elements within the bitstream within which the second transform coefficients are signaled. For example, the one or more syntax elements may indicate one or more of the transform kernel, the transform size, or the determination to use large approximate transform for the video block. The one or more syntax elements may, for example, be written to (i.e., signaled within) a block header, slice header, frame header, or other header or portion associated with the video block.

Referring next to FIG. 10, the technique 1000 for video decoding using approximate large transform is shown. At 1002, a transform kernel and a transform size are determined. The transform kernel and the transform size are determined for inverse transforming a second stage transform block associated with an encoded video block to decode. The transform kernel and a transform size are determined based on syntax elements decoded from a bitstream which includes the encoded video block. Determining the transform kernel and the transform size can thus, for example, include decoding one or more syntax elements indicative of the transform kernel and/or the transform size from the bitstream. For example, the transform kernel may be one of DCT, DST, ADST, or a trained transform. In another example, the transform size may be one of 4×4, 4×8, 8×4, 8×8, 8×16, 16×8, 16×16, 16×32, 32×16, 32×32, 32×64, 64×32, or 64×64.

At 1004, a first stage inverse transform is performed according to the transform kernel and the transform size against a second stage transform block. Performing the first stage inverse transform against the second stage transform block includes applying the transform kernel against second transform coefficients of the second stage transform block to obtain (e.g., calculate, determine, or identify) first transform coefficients, in which the second stage transform block is of the transform size. The first transform coefficients include transform coefficients resulting from the inverse transform performed against the second stage transform block.

At 1006, first stage transform blocks with deinterleaved transform coefficients are determined. The first stage transform blocks are each a transform block having the same transform size as the second stage transform block. Determining the first stage transform blocks includes deinterleaving the first transform coefficients obtained based on the first stage inverse transform performed against the second stage transform block. Deinterleaving the first transform coefficients includes rearranging the various sets of transform coefficients of the first transform coefficients to reduce the inter-correlations between the sets of transform coefficients. In particular, deinterleaving the first transform coefficients includes writing the respective DC coefficients of each of the first stage transform blocks to buffers associated with those first stage transform blocks, followed by the first AC coefficients of each according to a scan order, followed by the second AC coefficients of each according to the scan order, and so on until all transform coefficients of all first stage transform blocks are deinterleaved and represented by (e.g., included in) the first stage transform blocks. In at least some cases, the deinterleaved transform coefficients are read from (e.g., removed from) a buffer associated with the second stage transform block as they are written to the buffers associated with the respective ones of the first stage transform blocks. Thus, the second stage transform block included transform coefficients from multiple transform blocks (e.g., from each of the first stage transform blocks) rather than from a single transform block.

At 1008, a second stage inverse transform is performed according to the transform kernel and the transform size against the first stage transform blocks. Performing the second stage inverse transform against the first stage transform blocks includes applying the transform kernel against the deinterleaved transform coefficients of the first stage transform blocks to obtain (e.g., calculate, determine, or identify) a prediction residual. For example, applying the transform kernel against the deinterleaved transform coefficients can include, for each of the first stage transform blocks, reading the respective deinterleaved transform coefficients from the buffer associated with the first stage transform block. The prediction residual includes values resulting from the inverse transform performed against the first stage transform blocks. The prediction residual is then output for further processing, for example, for reconstruction, filtering, and output within an output video stream or for storage.

In some implementations, the technique 1000 can include determining whether to use large approximate transform for inverse transforming the encoded video block. For example, a syntax element (e.g., one or more bits) may be signaled within a block header, slice header, frame header, or other header or portion associated with the encoded video block to indicate whether to use large approximate transform for decoding the encoded video block (e.g., whether large approximate transform was used during an encoding of the encoded video block). Where a determination is made to use large approximate transform for inverse transforming the encoded video block, the technique 1000 proceeds to 1002, where the transform kernel and transform size are determined. However, where a determination is made to not use large approximate transform for inverse transforming the encoded video block (i.e., such that a small transform size or other transform size for which the subject codec is configured for direct use), the technique 1000 instead skips the processing at 1002 through 1008 and instead performs a conventional, direct inverse transform against the transform coefficients decoded from the bitstream, which are then output for further processing at the decoder performing the technique 1000.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

Implementations of the transmitting station 102 and/or the receiving station 106 (and the algorithms, methods, instructions, etc., stored thereon and/or executed thereby, including by the encoder 400 and the decoder 500, or another encoder or decoder as disclosed herein) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102 can encode content into an encoded video signal and transmit the encoded video signal to the communications device. In turn, the communications device can then decode the encoded video signal. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described implementations and other aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method for encoding a video block, the method comprising:
determining a transform kernel and a transform size for transforming a residual block associated with the video block;
obtaining first transform coefficients by performing, according to the transform kernel and the transform size, a first stage transform against first stage transform blocks partitioned from the residual block;
determining a second stage transform block by interleaving the first transform coefficients;
obtaining second transform coefficients by performing, according to the transform kernel and the transform size, a second stage transform against the second stage transform block; and
outputting the second transform coefficients for further processing.

2. The method of claim 1, wherein determining the transform kernel and the transform size for transforming the residual block associated with the video block comprises:
selecting the transform kernel according to rate-distortion costs determined for one or more candidate transform kernels based on a rate-distortion optimization process performed against the residual block; and
determining the transform size by performing a transform-level partitioning against the residual block according to energy concentrations represented within values of the residual block.

3. The method of claim 1, wherein obtaining the first transform coefficients by performing, according to the transform kernel and the transform size, the first stage transform against the first stage transform blocks partitioned from the residual block comprises:
applying the transform kernel against values within the first stage transform blocks to obtain the first transform coefficients, wherein each of the first stage transform blocks is of the transform size.

4. The method of claim 1, wherein determining the second stage transform block by interleaving the first transform coefficients comprises:
rearranging sets of transform coefficients of the first transform coefficients to align inter-correlations between the sets of transform coefficients, wherein the second stage transform block has a same size as each of the first stage transform blocks.

5. The method of claim 1, wherein the interleaved transform coefficients are written to a buffer associated with the second stage transform block and obtaining the second transform coefficients by performing, according to the transform kernel and the transform size, the second stage transform against the second stage transform block comprises:
reading the interleaved transform coefficients from the buffer associated with the second stage transform block; and
applying the transform kernel against the interleaved transform coefficients read from the buffer to obtain the second transform coefficients.

6. The method of claim 1, comprising:
determining whether to use large approximate transform for transforming the video block.

7. The method of claim 1, comprising:
signaling one or more syntax elements within a bitstream within which the second transform coefficients are signaled, wherein the one or more syntax elements indicate one or more of the transform kernel, the transform size, or a determination to use large approximate transform for the video block.

8. The method of claim 1, wherein the transform kernel is one of DCT, DST, ADST, or a trained transform and the transform size is one of 4×4, 4×8, 8×4, 8×8, 8×16, 16×8, 16×16, 16×32, 32×16, 32×32, 32×64, 64×32, or 64×64.

9. A method for decoding an encoded video block, the method comprising:
determining, based on syntax elements decoded from a bitstream which includes the encoded video block, a transform kernel and a transform size for inverse transforming a second stage transform block associated with the encoded video block;
obtaining first transform coefficients by performing, according to the transform kernel and the transform size, a first stage inverse transform against second transform coefficients of the second stage transform block;
determining first stage transform blocks by deinterleaving the first transform coefficients;
obtaining a prediction residual by performing, according to the transform kernel and the transform size, a second stage inverse transform against each of the first stage transform blocks; and
outputting the prediction residual for further processing.

10. The method of claim 9, obtaining the first transform coefficients by performing the first stage inverse transform against the second transform coefficients of the second stage transform block comprises:
applying the transform kernel against the second transform coefficients of the second stage transform block to obtain the first transform coefficients, wherein the second stage transform block is of the transform size.

11. The method of claim 9, wherein determining the first stage transform blocks by deinterleaving the first transform coefficients comprises:
rearranging sets of transform coefficients of the first transform coefficients to reduce inter-correlations between the sets of transform coefficients.

12. The method of claim 9, wherein determining the first stage transform blocks by deinterleaving the first transform coefficients comprises:
reading the first transform coefficients from a buffer associated with the second stage transform block; and
writing the deinterleaved first transform coefficients to buffers associated with respective ones of the first stage transform blocks.

13. The method of claim 9, wherein obtaining the prediction residual by performing the second stage inverse transform against each of the first stage transform blocks comprises:
applying the transform kernel against the deinterleaved transform coefficients of the first stage transform blocks to obtain the prediction residual.

14. The method of claim 9, wherein each of the first stage transform blocks has a same transform size as the second stage transform block.

15. The method of claim 9, wherein the transform kernel is one of DCT, DST, ADST, or a trained transform and the transform size is one of 4×4, 4×8, 8×4, 8×8, 8×16, 16×8, 16×16, 16×32, 32×16, 32×32, 32×64, 64×32, or 64×64.

16. A method, comprising:
determining first stage transform blocks by deinterleaving first transform coefficients obtained based on a first stage inverse transform performed, according to a transform kernel and transform size indicated within a bitstream, against second transform coefficients of a second stage transform block encoded within the bitstream; and
outputting a prediction residual obtained based on a second stage inverse transform performed, according to the transform kernel and the transform size, against each of the first stage transform blocks.

17. The method of claim 16, wherein determining the first stage transform blocks by deinterleaving the first transform coefficients obtained based on the first stage inverse transform performed against the second transform coefficients of the second stage transform block encoded within the bitstream comprises:
reading the first transform coefficients from a buffer associated with the second stage transform block; and
deinterleaving the first transform coefficients by rearranging sets of transform coefficients of the first transform coefficients to reduce inter-correlations between the sets of transform coefficients.

18. The method of claim 16, wherein outputting the prediction residual obtained based on the second stage inverse transform performed against each of the first stage transform blocks comprises:
reading ones of the deinterleaved first transform coefficients from buffers associated with ones of the first stage transform blocks; and
applying the transform kernel against the deinterleaved transform coefficients of the first stage transform blocks to obtain the prediction residual.

19. The method of claim 16, comprising:
determining to use large approximate transform based on a syntax element signaled within the bitstream.

20. The method of claim 16, wherein each of the first stage transform blocks has a same transform size as the second stage transform block.
